(19) United States
(12) Patent Application Publication
(10) Pub. No.: US 2013/0278741 A1
(43) Pub. Date: Oct. 24, 2013

(54) EAR HANGING TYPE EYE CONTROL DEVICE

(71) Applicants: Chia-Chun TSOU, New Taipei City (TW); Chih-Heng Fang, New Taipei City (TW); Ming-Chen Lai, New Taipei City (TW); Ming Hsien Wu, New Taipei City (TW)

(72) Inventors: Chia-Chun TSOU, New Taipei City (TW); Chih-Heng Fang, New Taipei City (TW); Ming-Chen Lai, New Taipei City (TW); Ming Hsien Wu, New Taipei City (TW)

(21) Appl. No.: 13/584,081

(22) Filed: Aug. 13, 2012

(30) Foreign Application Priority Data
Apr. 20, 2012 (TW) 101114126

(51) Int. Cl. H04N 7/18

(52) U.S. Cl. 348/78; 348/E07.085

(57) ABSTRACT

An ear hanging type eye control device includes a main body, an ear hook, and an image-taking module. The main body is provided therein with the electronic components necessary for operation. The ear hook extends outward from the main body so as to hook over one of the user's ears. The image-taking module is connected to the main body and is configured for taking images of the user's eyes. The ear hanging type eye control device is capable of detecting and identifying eyeball movements and executing a variety of control instructions.

### BACKGROUND OF THE INVENTION

1. Technical Field

The present invention relates to an eye control device and, more particularly, to an ear hanging type eye control device to be hooked over one of the user's ears.

2. Description of Related Art

Eye movements can be used to control equipment and has been widely researched. Many techniques have been disclosed and are well known to the public. Taking US Patent Publication No. 2011/0279666 for example, the major technical features thereof include providing a pair of specially designed eyeglasses to be worn by the user and placing a display cabinet in front of the user, wherein the display cabinet houses a plurality of products and is mounted with a number of fixed-position sensors at appropriate positions. The frame of the eyeglasses is equipped with a CCD camera for monitoring the user's vision range and transmitting signals to a data processing and storage unit. The frame is also equipped with a position sensor. The spatial relationship between the user and the display cabinet can be determined by signal communication between the position sensor and the fixed-position sensors. The '666 patent application is intended to address marketing issues and, more particularly, to facilitate researches and surveys regarding merchandise development. By observing what the user gazes at, or how long of the user's sight is fixed on, the manufacturer of the products can know which product's packaging is preferred by consumers. This technique has been used in the various eye trackers developed by Tobii Technology.

U.S. Pat. No. 6,003,991 discloses a device for use in the medical field. More specifically, the device is a pair of eyeglasses to be worn by a patient, with a camera equipped in front of the eyeglasses to take images of the user's eyes. The images are transferred to a computer and a screen via transmission lines so that a doctor can clearly observe the patient's eye conditions in order to carry out treatment or medical study.

Jason S. Babcock and Jeff B. Pelz of Rochester Institute of Technology mentioned a novel design for an eye-tracking device in their co-authored paper “Building a Lightweight Eyetracking Headgear.” This eye-tracking device is a pair of lightweight and low-cost eyeglasses that support open-source code. Additionally, a camera is provided on the frame of the eyeglasses and is aimed at the wearer's eyes so as to track eye movements.

The “EyeWriter” developed in 2007 by Graffiti Research Lab, OpenFrameworks, The Ebeling Group, etc. is an eye control device similar to that developed by Babcock et al. The development of the “EyeWriter” was started by a group of software developers wishing to enable Tony Quan—also known as Temp One, a graffiti artist who at the time was gradually losing the mobility of his limbs due to amyotrophic lateral sclerosis (ALS)—to paint with his eyes. The eyeglass frame of the “EyeWriter” is fitted with two cameras targeted at the wearer's eyes. The cameras can detect eye movements and work in conjunction with open-source data reading software, thus allowing Tony Quan to carry on his painting career.

In “A Wearable Gaze Tracking System for Children in Unconstrained Environments” written by Basilio Noris, Jean-Baptiste Keller, and Aude Billard, a wearable eye-tracking device is disclosed as essentially including two adjacent cameras, one located above the other, and a mirror provided between the cameras. The upper camera records images in front of the user. The lower camera, on the other hand, captures images of the user's hand movements and takes images of the user's eyes via the mirror at the same time. The device is designed mainly to monitor children's learning behaviors and interaction with one another and is equally applicable to pets such as dogs and cats. To use, the device is clipped to a hat before the hat is worn by a child.

The prior art techniques stated above are, in fact, similar solutions to different problems, and a study of the aforementioned devices reveals their common approach, which is to provide an eyeglass frame with at least one camera for taking images of the eyes. These solutions, though working effectively, are rather inconvenient for those who already wear eyeglasses and those who are bedridden. In order to support the additional camera(s), an eyeglass frame must be redesigned specifically for the task, making it impossible for the user to freely choose the style of the frame. For a patient who, due to a surgical operation or other reasons, must lie in bed and cannot turn his or her body without a nurse's help, the eyeglass frame tends to shift away from the correct image-taking position once the patient's body is turned to one side for a change of dressing or for catheter replacement. Moreover, whether the patient's body is turned to the left or to the right, the eyeglass frame, which is hooked on both ears, is bound to press against one of the ears. In short, the prior art leaves much to be desired in use.

### SUMMARY OF THE INVENTION

In view of the above, the present invention provides an ear hanging type eye control device which, instead of relying on the two temples of an eyeglass frame as is typically the case in the prior art, is configured to be hooked over only one of the user's ears and thereby overcome the aforesaid problems.

The present invention is to provide an ear hanging type eye control device, comprising: a main body, which is provided therein with electronic components necessary for operation; an ear hook, which is connected to the main body and is configured to hook over one of a user's ears; and an image-taking module, which is electrically connected to the main body and is configured for taking images of the user's eyes. In a preferable embodiment, the ear hook is made of a flexible material and is deformable when subjected to a force.

According to the present invention, the ear hanging type eye control device further comprises an extension arm connected to the main body, wherein the image-taking module is configured to the extension arm.

In a preferable embodiment of the present invention, the extension arm of the ear hanging type eye control device is connected to the main body in such a way that the extension arm is rotatable relative to the main body. The way for connection is without limitation and can be achieved by well known method in the art. A preferable embodiment is that the ear hanging type eye control device further comprises a pivot pin passing through the connected portion of the extension arm and the main body such that the extension arm is adjustable by rotating relative to the main body along a rotation axis defined by the pivot pin.

According to the ear hanging type eye control device of the present invention, the images taken by the image-taking module may further be converted to a signal to obtain the meaning of the user's eye movement image. Methods for transmitting the images to a computation unit are well known in the art, for example, using wireless transmission. Alternatively, the ear hanging type eye control device of the present invention may further comprise a signal transmission line for transmitting the images taken by the image-taking module to a computation unit via a wired manner.

According to the ear hanging type eye control device of the present invention, it further comprises a sound generation module, which is configured to the junction of the main body and the ear hook.

The ear hanging type eye control device of the present invention, further comprising a microphone electrically connected to the main body and configured for receiving a sound. In a preferable embodiment, the microphone is configured to the extension arm. In a more preferable embodiment, the microphone is configured to the end of the extension arm.

As the ear hanging type eye control device of the present invention is hooked over one ear only and therefore kept from blocking the user's field of vision, the present invention provides an advanced solution that will not compromise the user's view. Further, the device of the present invention does not require modification of an eyeglass wearer's existing eyeglass frame; thus, the novel and more user-friendly design disclosed herein is suitable for use by all users wearing or not wearing eyeglasses. In medical applications such as in a surgical operation, the device of the present invention will neither hinder nor interfere with the surgeon's view, thus ensuring a safe surgical environment. For those who are bedridden and cannot move freely, the device of the present invention will not prevent nurses from performing such routine operations as turning the patients' bodies to either side and cleaning, or changing the dressing for, a wound on the back. In contrast to the conventional eyeglass-type eye control devices, to whose inconveniences the medical personnel must adapt, the device disclosed herein is more convenient to use and hence helpful in all sorts of medical operations.

The ear hanging type eye control device of the present invention also contributes to driving safety, as explained in further detail below. The camera or cameras of a conventional eye control device are preferably directed to the user's eyes in order to obtain better images of the eyeballs. More specifically, the camera or cameras should be installed right in front of the user's eye, which, however, causes problems in driving. As a solution, the cameras in the prior art are shifted downward by a small distance so as not to block the user's entire field of vision. Practically speaking, a driver's field of vision should be complete and totally unblocked; therefore, partial blockage of the field of vision still raises safety concerns. Take truck drivers for example, as the driver's seat of a large truck is relatively high, a conventional eye control device tends to block the lower half of the driver's field of vision. In other words, the conventional eyeglass-type design attains the eye control function at the expense of a portion of the driver's field of vision. The blind spots, however, may give rise to traffic accidents. By contrast, the ear hanging type eye control device of the present invention takes images from the side and therefore will not block a driver's field of vision. Under the premise of ensuring driving safety, the present invention provides an eye control function that is easy to operate.

U.S. Pat. No. 7,974,664 discloses a Bluetooth earphone as shown in FIG. 2 and FIG. 3 thereof, with emphasis placed on the rotary design of the ear hook of the Bluetooth earphone. While the technical contents of the '664 patent disclose a structure to be hooked over one ear, the '664 patent does not teach or suggest the use of an eye image-taking module. In the present invention, however, the image-taking module is mounted on an extension arm and is angularly adjustable to the optimal position for taking images of the user's eyes, which technical features of the present invention cannot be anticipated by a person skilled in the art who has perused the disclosure of the '664 patent. The present invention also satisfies users' needs for eyeball communication control and is suitable for clinical medical uses. Hence, the technical solution provided by the present invention fully complies with the non-obviousness requirement for patent application. Techniques similar to those of the '664 patent can also be found in U.S. Pat. Nos. 7,289,640 and 8,027,638. These related patents are mentioned for reference by the examiner.

### BRIEF DESCRIPTION OF THE SEVERAL VIEWS OF THE DRAWINGS

The objects as well as the technical contents and features of the present invention will be best understood by referring to the following detailed description of a preferred embodiment in conjunction with the accompanying drawings, in which:

FIG. 1 is a schematic drawing of a preferred embodiment of the present invention.

### DETAILED DESCRIPTION OF THE INVENTION

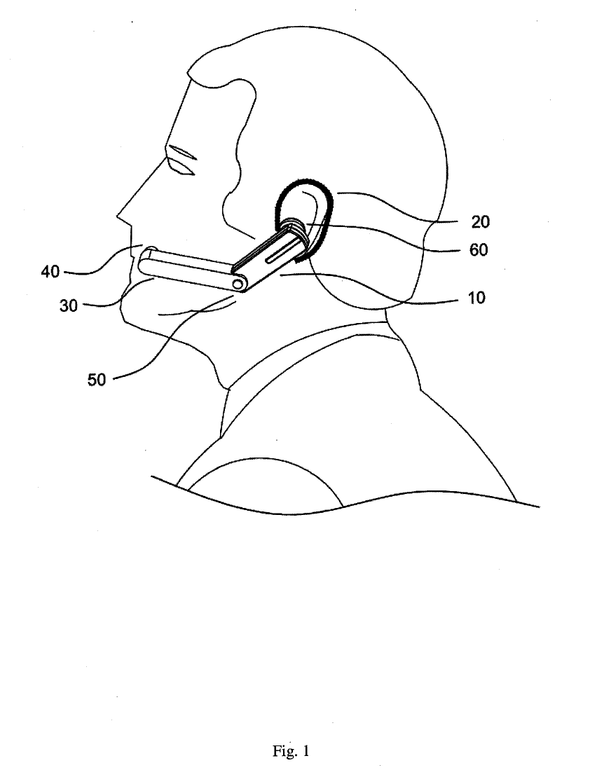

Referring to FIG. 1, which is a schematic drawing of the ear hanging type eye control device of the present invention. The ear hanging type eye control device comprises a main body 10, an ear hook 20, and an image-taking module 40, wherein the main body 10 is provided therein with electronic components necessary for operation; the ear hook 20 is connected to the main body and is a U shape to hook over one of a user's ears. In a preferable embodiment, the ear hook is made of a flexible material and is deformable when subjected to a force, so that the user can wear it with comfort.

As used herein, the term “electronic components necessary for operation” refers to electronic components that are essential to the operation of the present invention and are located in the disclosed ear hanging type eye control device, such as a battery, a transistor, a memory, a diode, and a printed circuit board and the like. As the main body 10 of the present invention is configured for receiving images taken by an image-taking module 40 and for converting the images into signals, the present invention also includes electronic components required for signal conversion.

The ear hanging type eye control device of the present invention further includes an extension arm 30 on which the image-taking module 40 is provided for taking images of the user's eyes. The extension arm 30 extends outward from one side of the main body 10. A pivot pin 50 passes through the main body 10 and the extension arm 30 such that the extension arm 30 can rotate relative to the main body 10 along a rotation axis defined by the pivot pin 50, allowing the user to adjust the wearing angle of the eye control device with ease. Nevertheless, it is to be understood that the connection between the extension arm 30 and the main body 10 is not limited to that described above. All connecting means capable of connecting the extension arm 30 and the main body 10 and allowing relative movement therebetween should fall within the scope of the present invention.

In the ear hanging type eye control device of the present invention, the image-taking module 40 is preferably provided at the distal end of the extension arm 30. As used herein, the term “distal end of the extension arm 30” refers to the end of the extension arm 30 that is opposite the end thereof fixed to the main body 10. More preferably, the extension arm 30 of the present invention is adjustable in length. With the extension arm 30 having an adjustable length and being rotatable relative to the main body 10 along the rotation axis defined by the pivot pin 50, the image-taking module 40 at the distal end of the extension arm 30 is advantageously adjustable to the optimal position for taking images of the user's eyes, wherein the adjustment can be made by increasing or decreasing the length, and adjusting the angle, of the extension arm 30 in accordance with the positions of the user's eyes.

The ear hanging type eye control device of the present invention further includes a signal transmission module (not shown) which is preferably provided in the main body 10. Thus, images taken by the image-taking module 40 of the ear hanging type eye control device of the present invention can be output through the signal transmission module. Alternatively, images taken by the image-taking module 40 are transmitted to the main body 10, which in turn converts the images into signals and then outputs the signals through the signal transmission module. The signal transmission module can transmit images or signals outward in a wireless manner, preferably to a computation unit where the images or signals are further processed and stored. It is understood that a signal transmission line (not shown) may also be used to transfer the signals generated by the main body 10 or the images taken by the image-taking module 40 and all sorts of data to the computation unit in a wired manner. The computation unit can compute the signals of the images (e.g., to determine the locations of the pupils, the number of times the user has blinked, or the rotation directions of the eyeballs) as desired and convert the image signals into the corresponding information according to the designed functions.

The ear hanging type eye control device of the present invention further includes a sound generation module 60. The sound generation module 60 is provided at the junction of the main body 10 and the ear hook 20 and can be placed on one side of the user's ear. Preferably, the sound generation module 60 is a module similar to an earphone and can be plugged into the user's ear. The sound generation module 60 can generate audible sound waves, wherein the generation of sound waves is carried out via an external computation device which transmits the desired signals to the sound generation module 60 through the signal transmission module. Moreover, the extension arm 30 of the ear hanging type eye control device of the present invention may be optionally provided with a microphone (not shown). The microphone can be located adjacent to the image-taking module 40 (i.e., the distal end of the extension arm 30) so as to receive the user's voice. Thus, the control and communication functions of the ear hanging type eye control device of the present invention can be enhanced and expanded with voice recording, emergency call for medical aid, and so on.

Upon receiving the images of the user's eyes, the ear hanging type eye control device of the present invention performs an analysis and determination process on eyeball movements and executes various control operations accordingly, such as automatically making or receiving a phone call, controlling the forward and backward movement of a wheelchair and like equipment, and controlling the acoustic volume and playing of music.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. An ear hanging type eye control device, comprising:
a main body, which is provided therein with electronic components necessary for operation;
an ear hook, which is connected to the main body and is configured to hook over one of a user's ears; and
an image-taking module, which is electrically connected to the main body and is configured for taking images of the user's eyes.

2. The ear hanging type eye control device of claim 1, further comprising an extension arm connected to the main body, wherein the image-taking module is configured to the extension arm.

3. The ear hanging type eye control device of claim 2, wherein the extension arm is connected to the main body in such a way that the extension arm is rotatable relative to the main body.

4. The ear hanging type eye control device of claim 2, further comprising a pivot pin passing through the connected portion of the extension arm and the main body such that the extension arm is adjustable by rotating relative to the main body along a rotation axis defined by the pivot pin.

5. The ear hanging type eye control device of claim 1, further comprising a signal transmission module for converting the images taken by the image-taking module into signals and transmitting the signals to a computation unit wirelessly.

6. The ear hanging type eye control device of claim 1, further comprising a signal transmission line for transmitting the images taken by the image-taking module to a computation unit via a wired manner.

7. The ear hanging type eye control device of claim 1, further comprising a sound generation module, which is configured to the junction of the main body and the ear hook.

8. The ear hanging type eye control device of claim 1, wherein the ear hook is made of a flexible material and is deformable when subjected to a force.

9. The ear hanging type eye control device of claim 1, further comprising a microphone electrically connected to the main body and configured for receiving a sound.

10. The ear hanging type eye control device of claim 9, wherein the microphone is configured to the main body or the extension arm.
